(19) United States
(12) Patent Application Publication
(10) Pub. No.: US 2026/0302229 A1
(43) Pub. Date: Oct. 1, 2026

(54) POSITIVE ELECTRODE PLATE, SECONDARY BATTERY, AND ELECTRONIC DEVICE

(71) Applicant: Ningde Amperex Technology Limited, Ningde (CN)

(72) Inventors: Xiaoqian LIU, Ningde (CN); Dongdong HAN, Ningde (CN)

(73) Assignee: Ningde Amperex Technology Limited, Ningde (CN)

(21) Appl. No.: 19/634,149

(22) Filed: Mar. 31, 2026

(30) Foreign Application Priority Data
Mar. 31, 2025 (CN) 202510390873.6

(51) Int. Cl. H01M 4/583; H01M 4/02; H01M 4/133; H01M 4/62; H01M 10/0525

(52) U.S. Cl. CPC H01M 4/583; H01M 4/133; H01M 4/623; H01M 4/625; H01M 10/0525; H01M 2004/021; H01M 2004/028

(57) ABSTRACT

A positive electrode plate includes a positive electrode current collector and a positive electrode active material layer disposed on at least one surface of the positive electrode current collector. The positive electrode active material layer includes a first carbon material. The first carbon material includes carbon fibers and individual carbon black particles and/or chain-like structures formed by the carbon black particles disposed on the surface of the carbon fibers. A tap density of the first carbon material is 0.005 g/cm³ to 0.30 g/cm³. An oil absorption value of the first carbon material is 100 ml/100 g to 1000 ml/100 g.

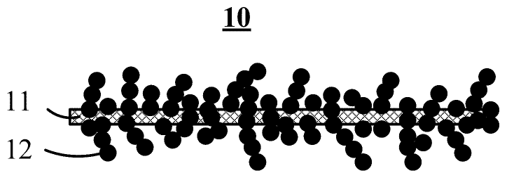

### CROSS-REFERENCE TO RELATED APPLICATION

The present application claims priority to Chinese Patent Application No. 202510390873.6, filed on Mar. 31, 2025, the disclosure of which is hereby incorporated by reference in its entirety.

### TECHNICAL FIELD

This application relates to the field of electrochemical technologies, and in particular to a positive electrode plate, a secondary battery, and an electronic device.

### BACKGROUND ART

Secondary batteries (such as lithium-ion batteries) have advantages such as high energy storage density, high open-circuit voltage, low self-discharge rate, long cycle life, and good safety, and are widely used in various fields such as energy storage, mobile electronic devices, electric vehicles, and aerospace devices. With the rapid development of mobile electronic devices and electric vehicles, the market has been pursuing lithium-ion batteries with lower internal resistance.

In the prior art, internal resistance of a lithium-ion battery is generally reduced by increasing the content of a positive electrode conductive agent in a positive electrode plate or reducing the content of a binder in the positive electrode plate. However, reducing the content of the positive electrode binder will reduce the cohesion of a positive electrode active material layer itself or an adhesion force between the positive electrode active material layer and a positive electrode current collector, making the lithium-ion battery prone to the problem of thickness expansion at high temperature (≥80° C.). Therefore, how to make lithium-ion batteries have good high-temperature storage performance without affecting the internal resistance has become a technical problem urgently to be solved by those skilled in the art.

### SUMMARY

The purpose of this application is to provide a positive electrode plate, a secondary battery, and an electronic device to reduce the internal resistance of the secondary battery.

It should be noted that in the summary of the invention of this application, a lithium-ion battery is used as an example of a secondary battery to explain this application, but the secondary battery of this application is not limited to lithium-ion batteries. The specific technical solutions are as follows:

A first aspect of this application provides a positive electrode plate, the positive electrode plate includes a positive electrode current collector and a positive electrode active material layer disposed on at least one surface of the positive electrode current collector, the positive electrode active material layer includes a first carbon material, the first carbon material includes carbon fibers and individual carbon black particles and/or chain-like structures formed by the carbon black particles disposed on the surface of the carbon fibers; a tap density of the first carbon material is 0.005 g/cm³ to 0.30 g/cm³; and an oil absorption value of the first carbon material is 100 ml/100 g to 1000 ml/100 g. In the positive electrode plate provided by the first aspect of this application, the first carbon material can connect the particles of the positive electrode active material by disposing individual carbon black particles and/or chain-like structures formed by the carbon black particles on the surface of the carbon fibers, so that the first carbon material can play both short-range conducting role and long-range conducting role. Compared with the conventional granular carbon black material in the prior art, the first carbon material can exert a more efficient conducting role. The tap density of the first carbon material is regulated within the range of this application, so that the first carbon material has a smaller tap density, making the first carbon material have relatively loose interior to better fill the pores between the particles of the positive electrode active material and enhance the continuity of conduction. The oil absorption value of the first carbon material is regulated within the range of this application, so that the gap structure of the first carbon material can absorb a larger amount of electrolyte, which is beneficial to improving the electrolyte retention capacity of the positive electrode plate for the electrolyte, so that the positive electrode plate can also have good ion conductivity in the later cycling stage of the secondary battery. Applying the positive electrode plate to a secondary battery is beneficial to improving the cycling performance in the later stage of charging and discharging of the secondary battery. In the positive electrode plate of this application, selecting the first carbon material and regulating the tap density and oil absorption value of the first carbon material within the ranges of this application are beneficial to constructing a stable and continuous conductive network with good conducting performance in the positive electrode active material layer, and are also beneficial to improving the electrolyte retention capacity of the positive electrode plate for the electrolyte, thereby improving the ion conductivity and electron conductivity of the positive electrode plate. Applying the positive electrode plate to a secondary battery can reduce the internal resistance of the secondary battery and improve the cycling performance of the secondary battery.

In some embodiments of this application, an average particle size of the carbon black particles is d₀ μm, and 0.005≤d₀≤0.1. Regulating the average particle size of the carbon black particles within the above range is beneficial to constructing a stable and continuous conductive network with good conducting performance in the positive electrode active material layer, and is also beneficial to improving the electrolyte retention capacity of the positive electrode plate for the electrolyte, thereby improving the ion conductivity and electron conductivity of the positive electrode plate. This can reduce the internal resistance of the secondary battery and improve the cycling performance of the secondary battery.

In some embodiments of this application, a diameter of the carbon fibers is Φ μm, and 0.01≤Φ≤1.00. Regulating the diameter of the carbon fibers within the above range is beneficial to improving the conductivity efficiency of the first carbon material to reduce the internal resistance of the secondary battery.

In some embodiments of this application, 1.5≤Φ/d₀≤8. Regulating the ratio Φ/d₀ of the carbon fiber diameter to the average particle size of the carbon black particles within the above range reduces the internal resistance of the secondary battery and improves the cycling performance of the secondary battery.

In some embodiments of this application, the positive electrode plate satisfies at least one of the following features: (a) 0.01≤d₀≤0.05; or (b) 0.05≤Φ≤0.1. This is beneficial to reducing the internal resistance of the secondary battery.

In some embodiments of this application, a length of the first carbon material is L₁ μm, and 1≤L₁≤50. Regulating the length of the first carbon material within the above range is beneficial to making the first carbon material exert its long-range conducting role on the basis of exerting its short-range conducting role, which can further reduce the internal resistance of the secondary battery and improve the cycling performance of the secondary battery.

In some embodiments of this application, a diameter of the first carbon material is D₁ μm, and 0.2≤D₁≤5. Regulating the diameter of the first carbon material within the above range allows the positive electrode plate to have higher ion conductivity and electron conductivity, thereby reducing the internal resistance of the secondary battery.

In some embodiments of this application, the first carbon material satisfies at least one of the following features: (1) the tap density of the first carbon material is 0.01 g/cm³ to 0.06 g/cm³; (2) the oil absorption value of the first carbon material is 400 ml/100 g to 700 ml/100 g; (3) a length of the first carbon material is L₁ μm, and 2≤L₁≤15; or (4) a diameter of the first carbon material is D₁ μm, and 0.5≤D₁≤2. This is beneficial to reducing the internal resistance of the secondary battery.

In some embodiments of this application, based on a mass of the positive electrode active material layer, a mass percentage of the first carbon material is W₁%, and 0.1≤W₁≤2.0. In some embodiments of this application, based on a mass of the positive electrode active material layer, a mass percentage of the first carbon material is W₁%, and 0.3≤W₁≤1.0. Regulating the mass percentage of the first carbon material within the above range is beneficial to the uniform distribution of the first carbon material in the positive electrode slurry, exerting the good short-range and long-range conducting roles of the first carbon material, so that the positive electrode plate has good ion conductivity and electron conductivity, and reducing the internal resistance of the secondary battery.

In some embodiments of this application, the positive electrode active material layer includes a second carbon material, the second carbon material includes carbon nanotubes, a diameter of the carbon nanotubes is D₂ nm, where 5≤D₂≤15, and a length of the carbon nanotubes is L₂ μm, where 1≤L₂≤5. Based on a mass of the positive electrode active material layer, a mass percentage of the carbon nanotubes is W₂%, and 0.2≤W₂≤0.8. Selecting the carbon nanotubes with the diameter and length within the ranges of this application, and regulating the mass percentage of the carbon nanotubes in the positive electrode active material layer within the above range, are beneficial to constructing a more stable conductive network in the positive electrode active material layer, and improving the ion conductivity and electron conductivity of the positive electrode plate, thereby reducing the internal resistance of the secondary battery.

In some embodiments of this application, the positive electrode active material layer includes a positive electrode binder, and the positive electrode binder includes at least one of polyvinylidene fluoride, vinylidene fluoride-hexafluoropropylene copolymer, polyacrylonitrile, polyacrylate, polyacrylic acid, polyacrylate salt, polyvinylpyrrolidone, polyamide, polyvinyl ether, polymethyl methacrylate, polytetrafluoroethylene, polyhexafluoropropylene, styrene-butadiene rubber, polypropylene, polyethylene, polytetrafluoroethylene, polyetherimide, hydrogenated nitrile rubber, or carboxymethyl cellulose salt. Based on a mass of the positive electrode active material layer, a mass percentage of the positive electrode binder is W₃%, and 0.8≤W₃≤3.0. The above types of positive electrode binders have good adhesion performance. Selecting the above types of positive electrode binders for use in the positive electrode active material layer, and regulating the mass percentage of the positive electrode binder in the positive electrode active material layer within the above range, are beneficial to making the secondary battery have a lower demolding probability on the basis of having lower internal resistance, and making the positive electrode plate have a lower thickness expansion rate, so that the secondary battery has good safety performance and cycling performance.

In some embodiments of this application, a saturated electrolyte retention rate of the positive electrode plate is 5% to 20%. This indicates that the positive electrode plate has a higher saturated electrolyte retention rate.

A second aspect of this application provides a secondary battery, which includes the positive electrode plate described in any of the foregoing embodiments. Therefore, the secondary battery has lower internal resistance.

A third aspect of this application provides an electronic device, which includes the secondary battery described in any of the foregoing embodiments. Therefore, the electronic device has good performance.

### Beneficial Effects of this Application

This application provides the positive electrode plate, the secondary battery, and the electronic device. The positive electrode plate includes the positive electrode current collector and the positive electrode active material layer disposed on the at least one surface of the positive electrode current collector. The positive electrode active material layer includes the first carbon material; the first carbon material includes the carbon fibers and the individual carbon black particles and/or chain-like structures formed by the carbon black particles disposed on the surface of the carbon fibers; the tap density of the first carbon material is 0.005 g/cm³ to 0.30 g/cm³; and the oil absorption value of the first carbon material is 100 ml/100 g to 1000 ml/100 g. In the positive electrode plate, the first carbon material can connect the particles of the positive electrode active material by disposing individual carbon black particles and/or chain-like structures formed by the carbon black particles on the surface of the carbon fibers, so that the first carbon material can play both a short-range conducting role and a long-range conducting role. Compared with the conventional granular carbon black material in the prior art, the first carbon material can exert a more efficient conducting role. The tap density of the first carbon material is regulated within the range of this application, so that the first carbon material has a smaller tap density, making the first carbon material have relatively loose interior to better fill the pores between the particles of the positive electrode active material and enhance the continuity of conduction. The oil absorption value of the first carbon material is regulated within the range of this application, so that the gap structure of the first carbon material can absorb more electrolyte, which is beneficial to improving the electrolyte retention capacity of the positive electrode plate for the electrolyte, so that the positive electrode plate can also have good ion conductivity in the later cycling stage of the secondary battery. Applying the positive electrode plate to a secondary battery is beneficial to improving the cycling performance in the later stage of charging and discharging of the secondary battery. In the positive electrode plate of this application, selecting the first carbon material and regulating the tap density and oil absorption value of the first carbon material within the ranges of this application are beneficial to constructing a stable and continuous conductive network with good conducting performance in the positive electrode active material layer, and are also beneficial to improving the electrolyte retention capacity of the positive electrode plate for the electrolyte, thereby improving the ion conductivity and electron conductivity of the positive electrode plate. Applying the positive electrode plate to a secondary battery can reduce the internal resistance of the secondary battery and improve the cycling performance of the secondary battery.

Certainly, any product or method implementing this application does not necessarily need to achieve all the advantages described above at the same time.

### BRIEF DESCRIPTION OF DRAWINGS

In order to more clearly illustrate the technical solutions in the embodiments of this application, the drawings needed in the description of the embodiments will be briefly introduced below. Obviously, the drawings in the following description are only some embodiments of this application. For those of ordinary skill in the art, other embodiments can also be obtained based on these drawings.

The FIGURE is a schematic diagram of a microstructure of a first carbon material in some embodiments of this application.

### REFERENCE SIGN

10. first carbon material, 11. carbon fiber, and 12. carbon black particle.

### DESCRIPTION OF EMBODIMENTS

The technical solutions in this application will be clearly described below in conjunction with the embodiments and drawings of this application. Obviously, the described embodiments are only a part of the embodiments of this application, not all the embodiments. All other embodiments obtained by those skilled in the art based on this application fall within the protection scope of this application.

A first aspect of this application provides a positive electrode plate, and the positive electrode plate includes a positive electrode current collector and a positive electrode active material layer disposed on at least one surface of the positive electrode current collector. The above “positive electrode active material layer disposed on at least one surface of the positive electrode current collector” means that the positive electrode active material layer can be disposed on one surface or two surfaces of the positive electrode current collector along its own thickness direction. The above “surface” can be a part of the surface of the positive electrode current collector or the entire surface of the positive electrode current collector. The positive electrode active material layer includes a first carbon material, and the first carbon material includes carbon fibers and individual carbon black particles and/or chain-like structures formed by the carbon black particles disposed on the surface of the carbon fibers. A tap density of the first carbon material is 0.005 g/cm³ to 0.30 g/cm³; and an oil absorption value of the first carbon material is 100 ml/100 g to 1000 ml/100 g.

It can be understood that in some embodiments, the first carbon material includes the carbon fibers and individual carbon black particles disposed on the surface of the carbon fibers. In some other embodiments, the first carbon material includes the carbon fibers and chain-like structures formed by the carbon black particles disposed on the surface of the carbon fibers. In still some other embodiments, the first carbon material includes the carbon fibers, and further includes carbon black particles and chain-like structures formed by the carbon black particles disposed on the surface of the carbon fibers. It should be noted that the above “chain-like structure” refers to a structure obtained by connecting two or more carbon black particles. As shown in the FIGURE, the first carbon material 10 includes carbon fibers 11 and carbon black particles 12, and the surface of the carbon fibers 11 is provided with individual carbon black particles 12, and further provided with chain-like structures formed by two or more carbon black particles 12.

For example, the tap density of the first carbon material is 0.005 g/cm³, 0.01 g/cm³, 0.02 g/cm³, 0.03 g/cm³, 0.04 g/cm³, 0.05 g/cm³, 0.06 g/cm³, 0.09 g/cm³, 0.10 g/cm³, 0.13 g/cm³, 0.15 g/cm³, 0.20 g/cm³, 0.22 g/cm³, 0.25 g/cm³, 0.27 g/cm³, 0.30 g/cm³, or any value between any two of the above values. If the tap density of the first carbon material is less than 0.005 g/cm³, the tap density of the first carbon material is too small. As a result, during the preparation of the positive electrode slurry, the viscosity of the positive electrode slurry is too large, leading to processing difficulties, and the first carbon material itself is not easy to disperse, leading to agglomeration, and affecting the exertion of its conducting performance, thereby affecting the electrolyte retention rate of the positive electrode plate and the internal resistance of the secondary battery. If the tap density of the first carbon material is greater than 0.30 g/cm³, the tap density of the first carbon material is too large, the volume of the first carbon material of the same weight is too small, and the first carbon material will easily fill the gaps of the positive electrode active material, affecting the exertion of the long-range conducting role of the first carbon material. As a result, the conductivity of the first carbon material becomes poor, the pores in the first carbon material are too few, the electrolyte retention rate of the positive electrode plate will decrease, the ion conductivity of the positive electrode plate becomes poor, and the subsequent cycling performance of the secondary battery decreases.

For example, the oil absorption value of the first carbon material is 100 ml/100 g, 200 ml/100 g, 300 ml/100 g, 400 ml/100 g, 500 ml/100 g, 600 ml/100 g, 700 ml/100 g, 800 ml/100 g, 900 ml/100 g, 1000 ml/100 g, or any value between any two of the above values. If the oil absorption value of the first carbon material is less than 100 ml/100 g, the oil absorption value of the first carbon material is too small, the amount of electrolyte that can be stored in the gap structure of the first carbon material is too small, the storage of electrolyte by the positive electrode plate is too little, the ion conductivity decreases, and the charging and discharging performance in the later cycling stage of the secondary battery becomes poor. If the oil absorption value of the first carbon material is greater than 1000 ml/100 g, the oil absorption value of the first carbon material is too large, during the preparation of the positive electrode slurry, the viscosity of the positive electrode slurry is too large, leading to processing difficulties, and the first carbon material itself is not easy to disperse, leading to agglomeration, affecting the exertion of its conducting performance, thereby affecting the electrolyte retention rate of the positive electrode plate and the internal resistance of the secondary battery.

Overall, in the positive electrode plate provided by the first aspect of this application, the first carbon material can connect the particles of the positive electrode active material by disposing individual carbon black particles and/or chain-like structures formed by the carbon black particles on the surface of the carbon fibers, so that the first carbon material can play both short-range conducting role and long-range conducting role. Compared with the conventional granular carbon black material in the prior art, the first carbon material can exert a more efficient conducting role. The tap density of the first carbon material is regulated within the range of this application, so that the first carbon material has a smaller tap density, making the first carbon material have relatively loose interior to better fill the pores between the particles of the positive electrode active material and enhance the continuity of conduction. The oil absorption value of the first carbon material is regulated within the range of this application, so that the gap structure of the first carbon material can absorb more electrolyte, which is beneficial to improving the electrolyte retention capacity of the positive electrode plate for the electrolyte, so that the positive electrode plate can also have good ion conductivity in the later cycling stage of the secondary battery. Applying the positive electrode plate to a secondary battery is beneficial to improving the cycling performance in the later stage of charging and discharging of the secondary battery. In the positive electrode plate of this application, selecting the first carbon material and regulating the tap density and oil absorption value of the first carbon material within the ranges of this application are beneficial to constructing a stable and continuous conductive network with good conducting performance in the positive electrode active material layer, and are also beneficial to improving the electrolyte retention capacity of the positive electrode plate for the electrolyte, thereby improving the ion conductivity and electron conductivity of the positive electrode plate. Applying the positive electrode plate to a secondary battery can reduce the internal resistance of the secondary battery and improve the cycling performance of the secondary battery.

In some embodiments of this application, the tap density of the first carbon material is 0.01 g/cm³ to 0.06 g/cm³. For example, the tap density of the first carbon material is 0.01 g/cm³, 0.02 g/cm³, 0.03 g/cm³, 0.04 g/cm³, 0.05 g/cm³, 0.06 g/cm³, or any value between any two of the above values. Regulating the tap density of the first carbon material within the above range allows the first carbon material to have a smaller tap density, making the first carbon material have relatively loose interior to better fill the pores between the particles of the positive electrode active material and enhance the continuity of conduction, which is beneficial to constructing a stable and continuous conductive network with good conducting performance in the positive electrode active material layer, and improving the ion conductivity and electron conductivity of the positive electrode plate, thereby reducing the internal resistance of the secondary battery.

In some embodiments of this application, the oil absorption value of the first carbon material is 400 ml/100 g to 700 ml/100 g. For example, the oil absorption value of the first carbon material is 400 ml/100 g, 500 ml/100 g, 600 ml/100 g, 700 ml/100 g, or any value between any two of the above values. With the oil absorption value of the first carbon material regulated within the above range, the gap structure of the first carbon material can absorb more electrolyte, which is beneficial to improving the electrolyte retention capacity of the positive electrode plate for the electrolyte, so that the positive electrode plate can also have good ion conductivity in the later cycling stage of the secondary battery. Applying the positive electrode plate to a secondary battery can reduce the internal resistance of the secondary battery and improve the cycling performance of the secondary battery.

This application has no particular limitation on the regulation manner of the tap density of the first carbon material, as long as the purpose of this application can be achieved. For example, it can be achieved by regulating the hot-melt temperature during the preparation of the first carbon material. Generally, a longer chain-like structure of the first carbon material means richer branches and smaller tap density.

This application has no particular limitation on the regulation manner of the oil absorption value of the first carbon material, as long as the purpose of this application can be achieved. For example, it can be achieved by regulating the addition ratio of the carbon black material and polyacrylonitrile (PAN) during the preparation of the first carbon material. Generally, a longer chain-like structure of the first carbon material means richer branches and larger oil absorption value.

In some embodiments of this application, an average particle size of the carbon black particles is d₀ μm, and 0.005≤d₀≤0.1. For example, the average particle size d₀ of the carbon black particles is 0.005, 0.01, 0.02, 0.025, 0.03, 0.04, 0.05, 0.06, 0.07, 0.08, 0.09, 0.1, or any value between any two of the above values. By regulating the average particle size of the carbon black particles within the above range, the probability of agglomeration of conductive carbon black is small, which is beneficial to making the conductive carbon black distributed on the surface of the carbon fibers in the form of individual particles or chain-like structures, and also reduces the probability of agglomeration of the first carbon material leading to an increase in the viscosity of the positive electrode slurry or limiting the exertion of its own conducting performance. Thus, this is beneficial to constructing a stable and continuous conductive network with good conducting performance in the positive electrode active material layer, and is also beneficial to improving the electrolyte retention capacity of the positive electrode plate for the electrolyte, thereby improving the ion conductivity and electron conductivity of the positive electrode plate. Applying the positive electrode plate to a secondary battery can reduce the internal resistance of the secondary battery and improve the cycling performance of the secondary battery.

In some embodiments of this application, 0.01≤d₀≤0.05. For example, the average particle size d₀ of the carbon black particles is 0.01, 0.02, 0.025, 0.03, 0.04, 0.05, or any value between any two of the above values. Regulating the average particle size of the carbon black particles within the above range is beneficial to obtaining a first carbon material with good conducting performance and low agglomeration probability, thereby being beneficial to constructing a stable and continuous conductive network with good conducting performance in the positive electrode active material layer, and is also beneficial to improving the electrolyte retention capacity of the positive electrode plate for the electrolyte, thereby improving the ion conductivity and electron conductivity of the positive electrode plate. Applying the positive electrode plate to a secondary battery can reduce the internal resistance of the secondary battery and improve the cycling performance of the secondary battery.

In this application, “the average particle size of the carbon black particles” refers to the average value of the equivalent diameters of the primary particles of the carbon black particles, and the equivalent diameter generally refers to the diameter of a sphere with the same volume as an object with an irregular shape. This application has no particular limitation on the regulation manner of the particle size of the carbon black particles, as long as the purpose of this application can be achieved. For example, it can be achieved by regulating the reaction temperature and reaction time during the preparation of the first carbon material; or it can be achieved by directly purchasing carbon black particles with particle sizes within the range of this application; or it can be achieved by crushing, grinding, or ball milling.

In some embodiments of this application, the diameter of the carbon fibers is Φ μm, and 0.01≤Φ≤1.00. For example, a diameter Φ of the carbon fibers is 0.01, 0.02, 0.05, 0.06, 0.08, 0.1, 0.2, 0.3, 0.4, 0.5, 0.6, 0.7, 0.8, 0.9, 1.00, or any value between any two of the above values. Regulating the diameter of the carbon fibers within the above range is beneficial to obtaining a longer first carbon material, and is also beneficial to an appropriate number of carbon black particles attaching to the surface of the carbon fibers. This is beneficial to the formation of branches in the chain-like structure of the carbon black particles, and extending the conductive path in the width direction of the first carbon material, thereby improving the conductivity efficiency of the first carbon material to reduce the internal resistance of the secondary battery.

In some embodiments of this application, 0.05≤Φ≤0.1. For example, the diameter Φ of the carbon fibers is 0.05, 0.06, 0.07, 0.08, 0.09, 0.1, or any value between any two of the above values. Regulating the diameter of the carbon fibers within the above range is beneficial to obtaining a longer first carbon material, and is also beneficial to an appropriate number of carbon black particles attaching to the surface of the carbon fibers. This is beneficial to the formation of branches in the chain-like structure of the carbon black particles, and extending the conductive path in the width direction of the first carbon material, thereby further improving the conductivity efficiency of the first carbon material to further reduce the internal resistance of the secondary battery.

This application has no particular limitation on the regulation manner of the diameter of the carbon fibers, as long as the purpose of this application can be achieved. For example, it can be achieved by regulating the concentration of PAN during the synthesis process.

In some embodiments of this application, 1.5≤Φ/d₀≤8. For example, the value of Φ/d₀ is 1.5, 2, 2.3, 2.7, 3, 3.3, 3.6, 4, 4.2, 4.7, 5, 6, 6.5, 7, 7.2, 7.7, 8, or any value between any two of the above values. Regulating the ratio Φ/d₀ of the carbon fiber diameter to the average particle size of the carbon black particles within the above range is beneficial to the carbon black particles attaching to the surface of the carbon fibers, forming branches in the chain-like structure, and extending the conductive path in the width direction of the first carbon material. This is beneficial to the first carbon material further filling the pores between the particles of the positive electrode active material, enhancing the continuity of conduction, and constructing a stable and continuous conductive network with good conducting performance in the positive electrode active material layer, and is also beneficial to improving the electrolyte retention capacity of the positive electrode plate for the electrolyte, thereby improving the ion conductivity and electron conductivity of the positive electrode plate. Applying the positive electrode plate to a secondary battery can reduce the internal resistance of the secondary battery and improve the cycling performance of the secondary battery.

In some embodiments of this application, a length of the first carbon material is L₁ μm, and 1≤L₁≤50. For example, the length L₁ of the first carbon material is 1, 2, 5, 7, 10, 12, 15, 20, 22, 27, 30, 35, 40, 42, 44, 47, 50, or any value between any two of the above values. Regulating the length of the first carbon material within the above range is beneficial to making the first carbon material exert its long-range conducting role on the basis of exerting its short-range conducting role, so that the first carbon material constructs a stable and continuous conductive network with good conducting performance in the positive electrode active material layer, thereby improving the ion conductivity and electron conductivity of the positive electrode plate. Applying the positive electrode plate to a secondary battery can reduce the internal resistance of the secondary battery and improve the cycling performance of the secondary battery.

In some embodiments of this application, a length of the first carbon material is L₁ μm, and 2≤L₁≤15. For example, the length L₁ of the first carbon material is 2, 5, 7, 10, 12, 15, or any value between any two of the above values. Regulating the length of the first carbon material within the above range is beneficial to making the first carbon material further exert its long-range conducting role on the basis of exerting its short-range conducting role, so that the first carbon material constructs a stable and continuous conductive network with good conducting performance in the positive electrode active material layer, thereby further improving the ion conductivity and electron conductivity of the positive electrode plate. Applying the positive electrode plate to a secondary battery can further reduce the internal resistance of the secondary battery and improve the cycling performance of the secondary battery.

This application has no particular limitation on the regulation manner of the length of the first carbon material, as long as the purpose of this application can be achieved. For example, it can be achieved by regulating the length of PAN.

In some embodiments of this application, a diameter of the first carbon material is D₁ μm, and 0.2≤D₁≤5. For example, the diameter D₁ of the first carbon material is 0.2, 0.3, 0.5, 0.7, 1.0, 1.4, 1.8, 2, 2.3, 2.7, 3, 3.3, 3.5, 3.9, 4.2, 4.5, 5, or any value between any two of the above values. Regulating the diameter of the first carbon material within the above range allows the first carbon material to have a good conductive path in the width direction, which can improve the conductivity efficiency of the first carbon material, and the first carbon material forms a continuous conductive network with good conducting performance in the positive electrode active material layer, and the positive electrode plate has higher ion conductivity and electron conductivity, thereby reducing the internal resistance of the secondary battery.

In some embodiments of this application, a diameter of the first carbon material is D₁ μm, and 0.5≤D₁≤2. For example, the diameter D₁ of the first carbon material is 0.5, 0.7, 1.0, 1.4, 1.8, 2, or any value between any two of the above values. Regulating the diameter of the first carbon material within the above range allows the first carbon material to have a good conductive path in the width direction, which can further improve the conductivity efficiency of the first carbon material. As a result, the first carbon material forms a continuous conductive network with good conducting performance in the positive electrode active material layer, and the positive electrode plate has higher ion conductivity and electron conductivity, thereby further reducing the internal resistance of the secondary battery.

This application has no particular limitation on the regulation manner of the diameter of the first carbon material, as long as the purpose of this application can be achieved. For example, it can be achieved by regulating the addition ratio of the carbon black material and PAN.

In some embodiments of this application, based on a mass of the positive electrode active material layer, a mass percentage of the first carbon material is W₁%, and 0.1≤W₁≤2.0. For example, the mass percentage W₁% of the first carbon material is 0.1%, 0.3%, 0.5%, 0.7%, 1.0%, 1.2%, 1.5%, 1.7%, 2.0%, or any value between any two of the above values. With the mass percentage of the first carbon material regulated within the above range, during the preparation of the positive electrode slurry, the probability of entanglement of the first slurry is low, which is beneficial to the uniform distribution of the first carbon material in the positive electrode slurry, thereby uniformly distributing in the positive electrode active material layer, connecting the particles of the positive electrode active material, forming a continuous conductive network in the positive electrode active material layer, and exerting the good short-range and long-range conducting role of the first carbon material, so that the positive electrode plate has good ion conductivity and electron conductivity. Applying the positive electrode plate to a secondary battery, the secondary battery has lower internal resistance.

In some embodiments of this application, based on a mass of the positive electrode active material layer, a mass percentage of the first carbon material is W₁%, and 0.3≤W₁≤1.0. For example, the mass percentage W₁% of the first carbon material is 0.3%, 0.5%, 0.7%, 0.9%, 1.0%, or any value between any two of the above values. With the mass percentage of the first carbon material regulated within the above range, during the preparation of the positive electrode slurry, the probability of entanglement of the first slurry is further reduced, which is beneficial to the uniform distribution of the first carbon material in the positive electrode slurry, thereby uniformly distributing in the positive electrode active material layer, connecting the particles of the positive electrode active material, forming a continuous conductive network in the positive electrode active material layer, and exerting the good short-range and long-range conducting role of the first carbon material, so that the positive electrode plate has good ion conductivity and electron conductivity. Applying the positive electrode plate to a secondary battery, the secondary battery has lower internal resistance.

In some embodiments of this application, the positive electrode active material layer includes a second carbon material, the second carbon material includes carbon nanotubes, a diameter of the carbon nanotubes is D₂ nm, where 5≤D₂≤15, and a length of the carbon nanotubes is L₂ μm, where 1≤L₂≤5. Based on a mass of the positive electrode active material layer, a mass percentage of the carbon nanotubes is W₂%, where 0.2≤W₂≤0.8. For example, the diameter D₂ of the carbon nanotubes is 5 nm, 7 nm, 8 nm, 9 nm, 10 nm, 11 nm, 12 nm, 13 nm, 14 nm, 15 nm, or any value between any two of the above values. For example, the length L₂ of the carbon nanotubes is 1 μm, 2 μm, 3 μm, 4 μm, 5 μm, or any value between any two of the above values. For example, the mass percentage W₂% of the carbon nanotubes is 0.2%, 0.3%, 0.4%, 0.5%, 0.6%, 0.7%, 0.8%, or any value between any two of the above values. Selecting the carbon nanotubes with the diameter and length within the range of this application, and regulating the mass percentage of the carbon nanotubes in the positive electrode active material layer within the above range, are beneficial to the carbon nanotubes connecting the particles of the positive electrode active material in series, maintaining the network conductive network between the particles, and reducing the probability of conductive network damage caused by expansion of the positive electrode plate during the charging and discharging cycle of the secondary battery. This is also beneficial to reducing the probability of entanglement of the first carbon material and the carbon nanotubes, and is beneficial to the uniform distribution of the first carbon material and the carbon nanotubes in the positive electrode slurry, thereby uniformly distributing in the positive electrode active material layer to fully exert their conducting performance. Thus, this is beneficial to constructing a more stable conductive network in the positive electrode active material layer, and improving the ion conductivity and electron conductivity of the positive electrode plate, thereby reducing the internal resistance of the secondary battery.

This application has no particular limitation on the regulation manner of the length and diameter of the carbon nanotubes, as long as the purpose of this application can be achieved. For example, it can be achieved by the rotation speed and time of sand milling during the preparation of the carbon nanotubes. Generally, a larger rotation speed and longer time of sand milling means a smaller diameter and shorter length of the carbon nanotubes; and a smaller rotation speed and shorter time of sand milling means a larger diameter and longer length of the carbon nanotubes. Alternatively, it can be achieved by purchasing commercially available carbon nanotubes with diameter and length meeting the needs of this application.

In some embodiments of this application, the positive electrode active material layer includes a positive electrode binder, and the positive electrode binder includes at least one of polyvinylidene fluoride, vinylidene fluoride-hexafluoropropylene copolymer, polyacrylonitrile, polyacrylate, polyacrylic acid, polyacrylate salt, polyvinylpyrrolidone, polyamide, polyvinyl ether, polymethyl methacrylate, polytetrafluoroethylene, polyhexafluoropropylene, styrene-butadiene rubber, polypropylene, polyethylene, polytetrafluoroethylene, polyetherimide, hydrogenated nitrile rubber, or carboxymethyl cellulose salt. Based on a mass of the positive electrode active material layer, a mass percentage of the positive electrode binder is W₃%, and 0.8≤W₃≤3.0. For example, the mass percentage W₃% of the positive electrode binder is 0.8%, 1.0%, 1.2%, 1.5%, 1.8%, 2.0%, 2.3%, 2.5%, 2.8%, 3.0%, or any value between any two of the above values. The above types of positive electrode binders have good adhesion performance. Selecting the above types of positive electrode binders for use in the positive electrode active material layer, and regulating the mass percentage of the positive electrode binder in the positive electrode active material layer within the above range, are beneficial to the uniform dispersion of the first carbon material and/or carbon nanotubes in the positive electrode slurry to exert the good conductivity of the first carbon material and/or carbon nanotubes, and are also beneficial to offering a good adhesion force between the positive electrode active material layer and the positive electrode current collector or the separator. This is beneficial to making the secondary battery have a lower demolding probability on the basis of having lower internal resistance, and the positive electrode plate have a lower thickness expansion rate, so that the secondary battery has good safety performance and cycling performance.

In some embodiments of this application, a saturated electrolyte retention rate of the positive electrode plate is 5% to 20%. For example, the saturated electrolyte retention rate of the positive electrode plate is 5%, 7%, 9%, 11%, 12%, 15%, 17%, 20%, or any value between any two of the above values. Regulating the saturated electrolyte retention rate of the positive electrode plate within the above range indicates that the positive electrode plate has a higher saturated electrolyte retention rate, the positive electrode plate has a higher electrolyte retention capacity for the electrolyte, and the secondary battery can still have sufficient electrolyte in the later stage of the charging and discharging cycle, so that the positive electrode plate has good ion conductivity and electron conductivity, which is beneficial to making the secondary battery have lower internal resistance and good cycling performance.

This application has no particular limitation on the regulation manner of the saturated electrolyte retention rate of the positive electrode plate, as long as the purpose of this application can be achieved. For example, it can be achieved by regulating the oil absorption value of the first carbon material. Generally, a larger oil absorption value of the first carbon material means a larger saturated electrolyte retention rate of the positive electrode plate; and a smaller oil absorption value of the first carbon material means a smaller saturated electrolyte retention rate of the positive electrode plate.

In some embodiments of this application, the positive electrode active material layer includes a positive electrode active material. This application has no particular limitation on the type and content of the positive electrode active material, as long as the purpose of this application can be achieved. For example, the positive electrode active material includes but is not limited to at least one of lithium cobalt oxide, lithium manganate, lithium nickelate, nickel cobalt manganese lithium oxide, nickel cobalt aluminum lithium oxide, lithium iron phosphate, lithium iron manganese phosphate, lithium vanadium phosphate, lithium-rich manganese-based material, or lithium titanate. For example, based on the mass of the positive electrode active material layer, the mass percentage of the positive electrode active material is 94.2% to 98.9%.

In some embodiments of this application, the positive electrode active material layer includes a first carbon material, a positive electrode binder, and a positive electrode active material. In some other embodiments of this application, the positive electrode active material layer includes a first carbon material, a second carbon material, a positive electrode binder, and a positive electrode active material.

This application has no particular limitation on the positive electrode current collector, as long as the purpose of this application can be achieved. For example, the positive electrode current collector can include aluminum foil or aluminum alloy foil. In this application, there is no particular limitation on the thickness of the positive electrode current collector and the positive electrode active material layer, as long as the purpose of this application can be achieved. For example, the thickness of the positive electrode current collector is 5 μm to 20 μm. The thickness of the single-layer positive electrode active material layer is 30 μm to 120 μm.

This application has no particular limitation on the preparation method of the first carbon material, as long as the purpose of this application can be achieved. For example, the preparation method of the first carbon material includes but is not limited to the following steps: uniformly hot-melt blending the carbon black material and polyacrylonitrile (PAN) at 180° C. to 200° C. to completely melt PAN, and uniformly dispersing the carbon black material in the molten PAN; then using electrospinning to form carbon fibers, pre-oxidizing the carbon fibers in an inert atmosphere, carbonizing in a nitrogen atmosphere, and graphitizing in a nitrogen atmosphere to form the first carbon material, where the pre-oxidation temperature is 200° C. to 300° C., and the time is 2 h to 4 h; the carbonization temperature is 1000° C. to 1500° C., and the time is 1 h to 2 h; the graphitization temperature is 2500° C. to 3000° C., and the time is 1 h to 2 h. This application has no particular limitation on the mass ratio of the above carbon black material to PAN, as long as the purpose of this application can be achieved. For example, the mass ratio of the carbon black material to PAN is (1 to 8):1. This application has no particular limitation on the weight average molecular weight of the above PAN, as long as the purpose of this application can be achieved. For example, the weight average molecular weight Mw of PAN is 80 W to 120 W. This application has no particular limitation on the above inert atmosphere, as long as the purpose of this application can be achieved. For example, the inert atmosphere is a mixed gas of air and nitrogen, and the mass ratio of air to nitrogen in the mixed gas is (10 to 30):(70 to 90).

This application has no particular limitation on the preparation method of the positive electrode plate, and known preparation methods in the art can be used, as long as the purpose of this application can be achieved. For example, the preparation method of the positive electrode plate includes but is not limited to the following steps: (1) uniformly mixing the first carbon material, the positive electrode binder, and the positive electrode active material, adding a solvent, and stirring uniformly to obtain a positive electrode slurry; (2) coating the positive electrode slurry on one surface of the positive electrode current collector, drying and cold pressing to form a positive electrode plate with a positive electrode active material layer disposed on one side. In another embodiment, the preparation method of the positive electrode plate includes the following steps: (1) uniformly mixing the first carbon material, the positive electrode binder, and the positive electrode active material, adding a solvent, and stirring uniformly to obtain a positive electrode slurry; (2) coating the positive electrode slurry on one surface of the positive electrode current collector, drying to form a positive electrode active material layer; (3) repeating step (2) on the other surface of the positive electrode current collector, and then cold pressing and slitting to obtain a positive electrode plate with positive electrode active material layers disposed on both sides. In still another embodiment, carbon nanotubes can be further added in the above step (1) to prepare a positive electrode active material layer containing the first carbon material, the second carbon material, the positive electrode binder, and the positive electrode active material at the same time. This application has no particular limitation on the solid content of the positive electrode slurry, as long as the purpose of this application can be achieved. For example, the solid content of the positive electrode slurry is 50 wt % to 80 wt %. This application has no particular limitation on the type of the above solvent, as long as the purpose of this application can be achieved. For example, the solvent can include but is not limited to N-methylpyrrolidone (NMP) or deionized water.

The second aspect of this application provides a secondary battery, which includes the positive electrode plate described in any of the foregoing embodiments. Therefore, the secondary battery has lower internal resistance.

In some embodiments of this application, the secondary battery includes a negative electrode plate. This application has no particular limitation on the negative electrode plate, as long as the purpose of this application can be achieved. In one embodiment, the negative electrode plate includes a negative electrode current collector and a negative electrode active material layer, the negative electrode active material layer is disposed on one surface or two surfaces of the negative electrode current collector, and the above “surface” can be a part of the surface of the negative electrode current collector or the entire surface of the negative electrode current collector. This application has no particular limitation on the negative electrode current collector, as long as the purpose of this application can be achieved. For example, the negative electrode current collector can include copper foil, copper alloy foil, nickel foil, stainless steel foil, titanium foil, foamed nickel, or foamed copper. The negative electrode active material layer of this application includes a negative electrode active material. This application has no particular limitation on the type of the negative electrode active material, as long as the purpose of this application can be achieved. For example, the negative electrode active material can include at least one of natural graphite, artificial graphite, mesocarbon microbeads (MCMB), hard carbon, soft carbon, silicon, silicon-carbon composite, SiOₓ (0<x<2), Li—Sn alloy, Li—Sn—O alloy, Sn, SnO, SnO₂, spinel-structured lithium titanate Li₄Ti₅O₁₂, Li—Al alloy, or metallic lithium. In this application, there is no particular limitation on the thickness of the negative electrode current collector and the negative electrode active material layer, as long as the purpose of this application can be achieved. For example, the thickness of the negative electrode current collector is 6 μm to 10 μm, and the thickness of the negative electrode active material layer is 30 μm to 130 μm. Optionally, the negative electrode active material layer can also include at least one of a negative electrode conductive agent, a dispersant, or a negative electrode binder. This application has no particular limitation on the type of the negative electrode conductive agent, dispersant, and negative electrode binder in the negative electrode active material layer, as long as the purpose of this application can be achieved. This application has no particular limitation on the mass ratio of the negative electrode active material, negative electrode conductive agent, dispersant, and negative electrode binder in the negative electrode active material layer, as long as the purpose of this application can be achieved. For example, the mass ratio of the negative electrode active material, negative electrode conductive agent, dispersant, and negative electrode binder in the negative electrode active material layer is (96-98):(0.5-2):(0-1.5):(1.0-1.9).

In some embodiments of this application, the secondary battery includes a separator, the separator is disposed between the positive electrode plate and the negative electrode plate to separate the positive electrode plate and the negative electrode plate, prevent internal short circuit of the secondary battery, allow electrolyte ions to pass freely, and not affect the progress of the electrochemical charging and discharging process. This application has no particular limitation on the separator, as long as the purpose of this application can be achieved. For example, the material of the separator can include but is not limited to at least one of polyolefin (PO) mainly composed of polyethylene (PE) and polypropylene (PP), polyester (for example, polyethylene terephthalate (PET) film), cellulose, polyimide (PI), polyamide (PA), spandex, or aramid. The type of the separator can include at least one of woven film, non-woven film, microporous film, composite film, rolled film, or spun film. In this application, there is no particular limitation on the thickness of the separator, as long as the purpose of this application can be achieved, for example, the thickness of the separator can be 3 μm to 30 μm.

In one embodiment of this application, the secondary battery includes an electrolyte. This application has no particular limitation on the type of the electrolyte, and those skilled in the art can select known electrolytes in the art according to actual needs, as long as the purpose of this application can be achieved.

In one embodiment of this application, the secondary battery includes a packaging bag for accommodating the positive electrode plate, the negative electrode plate, the separator, and the electrolyte. This application has no particular limitation on the type of the packaging bag, and those skilled in the art can select known packaging bags in the art according to actual needs, as long as the purpose of this application can be achieved.

The secondary battery of this application is not particularly limited, and it can include any device where electrochemical reaction occurs. For example, the secondary battery can include but is not limited to: lithium metal secondary battery, lithium-ion secondary battery (lithium-ion battery), lithium polymer secondary battery, or lithium-ion polymer secondary battery.

This application has no particular limitation on the preparation method of the secondary battery, and known preparation methods in the art can be selected, as long as the purpose of this application can be achieved. For example, the preparation method of the secondary battery includes but is not limited to the following steps: stacking the separator, the positive electrode plate, the separator, and the negative electrode plate in order, and winding or folding as needed to obtain an electrode assembly with a wound structure, placing the electrode assembly in a packaging bag, injecting the electrolyte into the packaging bag, and sealing to obtain a secondary battery; or stacking the separator, the positive electrode plate, the separator, and the negative electrode plate in order, then fixing the four corners of the entire laminated structure to obtain an electrode assembly with a laminated structure, placing the electrode assembly in a packaging bag, injecting the electrolyte into the packaging bag, and sealing to obtain a secondary battery.

The third aspect of this application provides an electronic device, which includes the secondary battery described in any of the foregoing embodiments. Therefore, the electronic device has good performance.

The electronic device of this application is not particularly limited, and it can be any electronic device known in the prior art. For example, the electronic device can include but is not limited to: notebook computer, pen input computer, mobile computer, e-book player, portable telephone, portable fax machine, portable copier, portable printer, stereo headset, video recorder, LCD TV, portable cleaner, portable CD player, mini disc, transceiver, electronic notebook, calculator, memory card, portable recorder, radio, backup power supply, motor, automobile, motorcycle, power-assisted bicycle, bicycle, lighting fixture, toy, game console, clock, power tool, flash lamp, camera, large household battery, and lithium ion capacitor.

### EXAMPLES

Hereinafter, examples and comparative examples are given to more specifically explain the embodiments of this application. Various tests and evaluations are performed according to the following methods.

### Test Methods and Devices

### Sampling Method of Positive Electrode Plate:

Under 25° C. conditions, a lithium-ion battery was discharged at a constant current of 0.2 C to 3.0 V. After the full discharge state was reached, the lithium-ion battery was disassembled, and a positive electrode plate was soaked in dimethyl carbonate (DMC) at room temperature for 60 min. It was then taken out and dried at room temperature to obtain the positive electrode plate.

Unless otherwise specified, the positive electrode plates in the following test methods were all obtained by the above method.

### Test for Tap Density:

(1) The positive electrode plate was soaked in a solvent N-methylpyrrolidone (NMP) for film removing, so that a film layer: the positive electrode active material layer was dissolved in the solvent. A disperser was used to disperse the mixture uniformly to obtain a first slurry.
(2) The above first slurry was taken, and centrifugation was used to separate a positive electrode binder in the first slurry, resulting in a second slurry containing a positive electrode active material and a first carbon material.
(3) Hydrochloric acid was used to digest the positive electrode active material (lithium cobalt oxide or nickel cobalt manganese lithium oxide) in the above second slurry, while hydrochloric acid-hydrogen peroxide was used to digest the lithium iron phosphate positive electrode active material. The mixture was then dried to obtain the first carbon material.
(4) 2 g to 10 g of the first carbon material from (3) was taken and placed into a tap density tester, where tap density tester may have a model of VTD-100. The weight was recorded as M (g), and the vibration frequency of the vibration tester was set to 250 times/min. After a total of 5000 vibrations, the volume was recorded as V (cm³). Tap density (g/cm³) of first carbon material=M/V.

### Test for Oil Absorption Value of First Carbon Material:

(1) A positive electrode plate was soaked in a solvent N-methylpyrrolidone (NMP) for film removing, so that a film layer: the positive electrode active material layer was dissolved in the solvent. A disperser was used to disperse the mixture uniformly to obtain a first slurry.
(2) The above first slurry was taken, and centrifugation was used to separate a positive electrode binder in the first slurry, resulting in a second slurry containing a positive electrode active material and a first carbon material.
(3) Hydrochloric acid was used to digest the positive electrode active material (lithium cobalt oxide or nickel cobalt manganese lithium oxide) in the above second slurry, while hydrochloric acid-hydrogen peroxide was used to digest the lithium iron phosphate positive electrode active material. The mixture was then dried to obtain the first carbon material.
(4) The paraffin oil+torque method was used to test an oil absorption value of the first carbon material:

A DABS-H model oil absorption meter was used. The first carbon material (sample) was added into the mixing tank of the oil absorption meter, and a constant drip speed device was used to add paraffin oil to the sample at a speed of 4 ml/min. As the oil absorption value of the sample increased, the mixture transformed from a free-flowing state to a semi-finished agglomerate, and the viscosity of the mixture continued to rise. This viscosity was transmitted to the torque sensing system of the oil absorption meter. When the viscosity of the mixture reached a torque value of 2 WN·m, the oil absorption meter and the titrator were automatically shut down simultaneously. The volume of the added oil was directly read from the reading burette, and the volume of oil absorbed per unit mass of the sample was defined as the oil absorption value of the sample.

### Test for Average Particle Size of Carbon Black Particles:

(1) A positive electrode plate was taken, and liquid nitrogen brittle fracture was used to obtain a cross section of a positive electrode active material layer on the positive electrode plate.
(2) The cross section obtained in (1) was observed under a scanning electron microscope (SEM). Tests were conducted at 10 different positions to measure an equivalent diameter of carbon black particles. An average value was taken as the average particle size, with a sample size of 50 carbon black particles.

### Test for Diameter of Carbon Fibers:

(1) A positive electrode plate was taken, and liquid nitrogen brittle fracture was used to obtain a cross section of a positive electrode active material layer on the positive electrode plate.
(2) The cross section obtained in (1) was observed under a scanning electron microscope (SEM). Tests were conducted at 10 different positions to measure a diameter of the carbon fibers. An average value was taken as the final result, with a total sample size of 30.

### Test for Length and Diameter of First Carbon Material:

(a) A positive electrode plate was taken, and liquid nitrogen brittle fracture was used to obtain a cross section of a positive electrode active material layer on the positive electrode plate.
(b) The cross section obtained in (a) was observed under a scanning electron microscope (SEM). Tests were conducted at 10 different positions. For each first carbon material, an average value of the 3 positions with the largest diameter was taken as its final diameter. At least 30 samples were tested, and the average value was taken as the final result.
(c) The cross section obtained in (a) was observed under a scanning electron microscope (SEM). Tests were conducted at 10 different positions to measure a length of intermediate carbon fiber. An average value was taken as the length of the first carbon material, with a total sample size of not less than 30.

### Test for Diameter and Length of Carbon Nanotubes:

(a) A positive electrode plate was taken, and liquid nitrogen brittle fracture was used to obtain a cross section of a positive electrode active material layer on the positive electrode plate;
(b) The cross section obtained in (a) was observed under SEM. Tests were conducted at 10 different positions to measure the diameter and length of the carbon nanotubes. An average value was taken as the target value, with 30 carbon nanotubes tested.

### Test for Electrolyte Retention Rate of Positive Electrode Plate:

(a) A positive electrode plate was taken, and its mass was tested as M₁. It was soaked in the electrolyte at 25° C. for 24 h, and then taken out and dried in an environment with a temperature of 25° C.±2° C. and a humidity of 10% to 15% for 10 min. Its mass was weighed as M₂. Electrolyte retention rate (%)=(M₂−M₁)/M₁×100%.

### Test for 360s Direct Current Internal Resistance (DCR) at 20% SOC (State of Charge) of Lithium-Ion Battery:

The Lithium-Ion Battery from the Example or Comparative Example was Subjected to the Following Test at 25±2° C.:
(1) It was left standing for 2 h;
(2) It was then charged at a constant current of 1.0 C to 4.5 V, followed by constant voltage charging at 4.5 V to 0.025 C; and left standing for 2 h.
(3) It was then discharged at a constant current of 0.2 C to 3.0 V, where the discharge capacity of this step was recorded as variable C₁, and left standing for 5 h.
(4) It was then charged at a constant current of 1.0 C₁ to 4.5 V, followed by constant voltage charging at 4.5 V to 0.025 C₁; and left standing for 10 min.
(5) It was then discharged at a constant current of 0.1 C₁ to 0.2 C₁, left standing for 15 min, where the voltage of the lithium-ion battery at this time was recorded as V₁, and then discharged at 1 C₁ rate for 360s, where the voltage was recorded as V₂. 360s DCR (mΩ) at 25° C. 20% SOC=(V₁−V₂)/1 C₁.

### Example 1-1

### <Preparation of Positive Electrode Plate>

Preparation of first carbon material: A carbon black material and polyacrylonitrile (PAN, weight average molecular weight Mw=110 W) were uniformly hot-melt blended at 190° C. to completely melt the PAN, and the carbon black was uniformly dispersed in the molten PAN. Electrospinning was then used to form carbon fibers. The carbon fibers were pre-oxidized in a mixed atmosphere of air and nitrogen (mass ratio of air to nitrogen 20:80) at 280° C. for 3 h, carbonized in a nitrogen atmosphere at 1350° C. for 1.5 h, and graphitized in a nitrogen atmosphere at 2700° C. for 1.5 h to form the first carbon material. The mass ratio of the carbon black material to PAN was 4:1.

A positive electrode active material lithium cobalt oxide, the first carbon material, and a positive electrode binder polyvinylidene fluoride (PVDF, weight average molecular weight 80 W) were mixed. N-methylpyrrolidone (NMP) was added as a solvent. These substances were stirred under the action of a vacuum mixer to form a uniform positive electrode slurry with a solid content of 75 wt %. The positive electrode slurry was uniformly applied on one surface of a 6 μm-thick positive electrode current collector aluminum foil and dried at 90° C. to obtain a positive electrode plate with a positive electrode active material layer applied on one surface. The above steps were then repeated on the other surface of the aluminum foil to obtain a positive electrode plate with positive electrode active material layers applied on two surfaces. Cold pressing and slitting were performed to obtain a positive electrode plate with a specification of 74 mm×851 mm for use. The coating weight of the positive electrode active material layer was 280 mg/1540.25 mm².

Based on the mass of the positive electrode active material layer, the mass percentage of the positive electrode active material was 98%, the mass percentage W₁ of the first carbon material was 0.8%, and the mass percentage of the positive electrode binder was 1.2%.

### <Preparation of Negative Electrode Plate>

A negative electrode active material artificial graphite, a negative electrode conductive agent acetylene black, a negative electrode binder styrene-butadiene rubber (SBR, weight average molecular weight 5×10⁶), and a dispersant carboxymethyl cellulose (CMC) were mixed in a mass ratio of 96:2:1:1. Deionized water was added as a solvent, and the substances were stirred under the action of a vacuum mixer to form a uniform negative electrode slurry with a solid content of 50 wt %. The negative electrode slurry was uniformly applied on one surface of an 8 μm-thick negative electrode current collector copper foil and dried at 90° C. to obtain a negative electrode plate with a 130 μm-thick negative electrode active material layer applied on one surface. The above steps were then repeated on the other surface of the copper foil to obtain a negative electrode plate with negative electrode active material layers applied on two surfaces. Cold pressing and slitting were performed to obtain a negative electrode plate with a specification of 76 mm×856 mm for use.

### <Preparation of Separator>

An 8 μm-thick polyethylene (PE) porous film was used as a separator.

### <Preparation of Electrolyte>

In a dry argon atmosphere, organic solvents ethylene carbonate, ethyl methyl carbonate, and diethyl carbonate were mixed in a mass ratio of 30:50:20 to obtain a base electrolyte. A lithium salt lithium hexafluorophosphate was then added to the base electrolyte, dissolved, and mixed uniformly to obtain an electrolyte with a lithium salt concentration of 1.15 mol/L.

### <Preparation of Lithium-Ion Battery>

The separator, positive electrode plate, separator, and negative electrode plate were stacked in sequence and wound to obtain an electrode assembly. The electrode assembly was placed in an aluminum-plastic film packaging bag, dried, and injected with the electrolyte. Processes such as vacuum sealing, standing, formation, degassing, and cutting were carried out to obtain a lithium-ion battery.

### Examples 1-2 to 1-31

The same as Example 1-1 except that the relevant preparation parameters were adjusted according to Table 1.

### Example 2-1

The same as Example 1-1 except that in <preparation of positive electrode plate>, carbon nanotubes were further introduced, the mass percentages of the first carbon material, carbon nanotubes, and positive electrode binder were adjusted according to Table 2, and the mass percentage of the positive electrode active material changed accordingly.

The sum of the mass percentages of the first carbon material, carbon nanotubes, positive electrode binder, and positive electrode active material was 100%.

### Examples 2-2 to 2-4

The same as Example 1-1 except that the relevant preparation parameters were adjusted according to Table 2.

When the mass percentage of the first carbon material was changed, the mass percentage of the positive electrode active material was adjusted accordingly, while the mass percentage of the positive electrode binder remained unchanged.

### Example 2-5

The same as Example 2-1 except that the relevant preparation parameters were adjusted according to Table 2.

When the mass percentage of the first carbon material was changed, the mass percentage of the positive electrode active material was adjusted accordingly, while the mass percentages of the positive electrode binder and carbon nanotubes remained unchanged.

### Example 2-6

The same as Example 1-1 except that the relevant preparation parameters were adjusted according to Table 2.

When the mass percentage of the first carbon material was changed, the mass percentage of the positive electrode active material was adjusted accordingly, while the mass percentage of the positive electrode binder remained unchanged.

### Examples 2-7 to 2-19

The same as Example 2-1 except that the relevant preparation parameters were adjusted according to Table 2.

When the mass percentage of the first carbon material and/or carbon nanotubes was changed, the mass percentage of the positive electrode active material was adjusted accordingly, while the mass percentages of other components in the positive electrode active material layer remained unchanged.

### Examples 3-1 to 3-6

The same as Example 2-12 except that the relevant preparation parameters were adjusted according to Table 3.

When the mass percentage of the positive electrode binder was changed, the mass percentage of the positive electrode active material was adjusted accordingly, while the mass percentages of other components in the positive electrode active material layer remained unchanged.

### Comparative Examples 1 and 6

The same as Example 1-1 except that the relevant preparation parameters were adjusted according to Table 1.

The preparation parameters and performance data of examples and comparative examples are shown in Tables 1 to 3.

TABLE 1

| | | | Average | | | | | | |
|---|---|---|---|---|---|---|---|---|---|
| | Tap | Oil | particle | | | | | | |
| | density of | absorption | size of | | | Length | Diameter | | |
| | first | value of | carbon | Diameter | | of first | of first | | |
| | carbon | first carbon | black | of carbon | | carbon | carbon | Electrolyte | Internal |
| | material | material | particles | fibers Φ | | material | material | retention | resistance |
| | (g/cm³) | (ml/100 g) | d₀ (μm) | (μm) | Φ/d₀ | L₁ (μm) | D₁ (μm) | rate (%) | (mΩ) |
| Example 1-1 | 0.03 | 500 | 0.03 | 0.08 | 2.67 | 8.00 | 1.20 | 13 | 45 |
| Example 1-2 | 0.005 | 1000 | 0.03 | 0.08 | 2.67 | 8.00 | 1.20 | 7 | 90 |
| Example 1-3 | 0.01 | 700 | 0.03 | 0.08 | 2.67 | 8.00 | 1.20 | 16 | 40 |
| Example 1-4 | 0.06 | 400 | 0.03 | 0.08 | 2.67 | 8.00 | 1.20 | 10 | 60 |
| Example 1-5 | 0.15 | 300 | 0.03 | 0.08 | 2.67 | 8.00 | 1.20 | 8 | 70 |
| Example 1-6 | 0.30 | 100 | 0.03 | 0.08 | 2.67 | 8.00 | 1.20 | 6 | 80 |
| Example 1-7 | 0.03 | 500 | 0.002 | 0.08 | 40.00 | 8.00 | 1.20 | 6 | 75 |
| Example 1-8 | 0.03 | 500 | 0.005 | 0.08 | 16.00 | 8.00 | 1.20 | 8 | 65 |
| Example 1-9 | 0.03 | 500 | 0.01 | 0.08 | 8.00 | 8.00 | 1.20 | 13 | 40 |
| Example 1-10 | 0.03 | 500 | 0.05 | 0.08 | 1.60 | 8.00 | 1.20 | 13 | 50 |
| Example 1-11 | 0.03 | 500 | 0.10 | 0.08 | 0.80 | 8.00 | 1.20 | 13 | 70 |
| Example 1-12 | 0.03 | 500 | 0.12 | 0.08 | 0.67 | 8.00 | 1.20 | 13 | 85 |
| Example 1-13 | 0.30 | 100 | 0.005 | 0.005 | 1.00 | 1.00 | 1.20 | 6 | 90 |
| Example 1-14 | 0.08 | 350 | 0.03 | 0.01 | 0.33 | 3.00 | 1.20 | 9 | 65 |
| Example 1-15 | 0.03 | 500 | 0.03 | 0.05 | 1.67 | 8.00 | 1.20 | 13 | 40 |
| Example 1-16 | 0.03 | 500 | 0.03 | 0.10 | 3.33 | 8.00 | 1.20 | 13 | 50 |
| Example 1-17 | 0.03 | 500 | 0.03 | 0.50 | 16.67 | 8.00 | 1.20 | 13 | 65 |
| Example 1-18 | 0.03 | 500 | 0.03 | 1.00 | 33.33 | 8.00 | 1.20 | 13 | 85 |
| Example 1-19 | 0.03 | 500 | 0.10 | 1.10 | 11.00 | 8.00 | 1.20 | 13 | 88 |
| Example 1-20 | 0.25 | 230 | 0.03 | 0.08 | 2.67 | 0.50 | 2.50 | 7 | 93 |
| Example 1-21 | 0.30 | 100 | 0.03 | 0.08 | 2.67 | 1.00 | 1.20 | 6 | 90 |
| Example 1-22 | 0.25 | 230 | 0.03 | 0.08 | 2.67 | 2.00 | 1.20 | 7 | 85 |
| Example 1-23 | 0.02 | 600 | 0.03 | 0.08 | 2.67 | 15.00 | 1.20 | 14 | 43 |
| Example 1-24 | 0.005 | 1000 | 0.03 | 0.08 | 2.67 | 50.00 | 1.20 | 7 | 90 |
| Example 1-25 | 0.005 | 1000 | 0.03 | 0.08 | 2.67 | 55.00 | 0.80 | 7 | 94 |
| Example 1-26 | 0.100 | 260 | 0.03 | 0.08 | 2.67 | 8.00 | 0.20 | 8 | 88 |
| Example 1-27 | 0.060 | 400 | 0.03 | 0.08 | 2.67 | 8.00 | 0.50 | 10 | 60 |
| Example 1-28 | 0.025 | 550 | 0.03 | 0.08 | 2.67 | 8.00 | 2.00 | 14 | 43 |
| Example 1-29 | 0.008 | 800 | 0.03 | 0.08 | 2.67 | 8.00 | 5.00 | 15 | 70 |
| Example 1-30 | 0.005 | 1000 | 0.03 | 0.08 | 2.67 | 8.00 | 6.00 | 6 | 90 |
| Example 1-31 | 0.008 | 900 | 0.03 | 0.08 | 2.67 | 8.00 | 1.20 | 8 | 285 |
| Comparative | 0.003 | 1200 | 0.03 | 0.08 | 2.67 | 8.00 | 1.20 | 4 | 120 |
| Example 1 | | | | | | | | | |
| Comparative | 0.40 | 80 | 0.03 | 0.08 | 2.67 | 8.00 | 1.20 | 3 | 130 |
| Example 2 | | | | | | | | | |
| Comparative | 0.003 | 800 | 0.03 | 0.08 | 2.67 | 8.00 | 1.20 | 5 | 100 |
| Example 3 | | | | | | | | | |
| Comparative | 0.40 | 800 | 0.03 | 0.08 | 2.67 | 8.00 | 1.20 | 3 | 110 |
| Example 4 | | | | | | | | | |
| Comparative | 0.03 | 1200 | 0.03 | 0.08 | 2.67 | 8.00 | 1.20 | 5 | 110 |
| Example 5 | | | | | | | | | |
| Comparative | 0.03 | 80 | 0.03 | 0.08 | 2.67 | 8.00 | 1.20 | 5 | 120 |
| Example 6 | | | | | | | | | |

From Examples 1-1 to 1-31 and Comparative Examples 1 to 6, it can be seen that in the secondary batteries of the examples of this application, by adding the first carbon material with individual carbon black particles and/or chain-like structures formed by carbon black particles disposed on the surface of carbon fibers in the positive electrode active material layer, and regulating the tap density and oil absorption value of the first carbon material within the range of this application, the 360s direct current internal resistance at 20% SOC of the secondary battery is lower, indicating that the secondary battery has lower internal resistance. In the comparative secondary batteries, the tap density and oil absorption value of the first carbon material are not within the range of this application, and the 360s direct current internal resistance at 20% SOC of the comparative secondary batteries is higher.

The average particle size d₀ of the carbon black particles generally also affects the internal resistance of the secondary battery. From Examples 1-1 and 1-7 to 1-12, it can be seen that using secondary batteries with the average particle size d₀ of the carbon black particles within the range of this application have lower 360s direct current internal resistance at 20% SOC, indicating that the secondary batteries have lower internal resistance.

The diameter Φ of the carbon fibers generally also affects the internal resistance of the secondary battery. From Examples 1-1 and 1-13 to 1-19, it can be seen that using secondary batteries with the diameter Φ of the carbon fibers within the range of this application have lower 360s direct current internal resistance at 20% SOC, indicating that the secondary batteries have lower internal resistance.

The ratio Φ/d₀ of the diameter of the carbon fibers to the average particle size of the carbon black particles generally also affects the internal resistance of the secondary battery. From Examples 1-1 and 1-7 to 1-19, it can be seen that using secondary batteries with the ratio Φ/d₀ of the diameter of the carbon fibers to the average particle size of the carbon black particles within the range of this application have lower 360s direct current internal resistance at 20% SOC, indicating that the secondary batteries have lower internal resistance.

The length L₁ and diameter D₁ of the first carbon material generally also affect the internal resistance of the secondary battery. From Examples 1-1 and 1-20 to 1-31, it can be seen that when the length L₁ and diameter D₁ of the first carbon material change, the tap density and oil absorption value of the first carbon material change accordingly. Using secondary batteries with the length L₁ and diameter D₁ of the first carbon material within the range of this application have lower 360s direct current internal resistance at 20% SOC, indicating that the secondary batteries have lower internal resistance.

TABLE 2

| | Mass | | | Mass | | |
|---|---|---|---|---|---|---|
| | percentage | Diameter | | percentage | | |
| | W₁ of first | D₂ of | Length L₂ | W₂ of | | |
| | carbon | carbon | of carbon | carbon | Electrolyte | Internal |
| | material | nanotubes | nanotubes | nanotubes | retention | resistance |
| | (%) | (nm) | (μm) | (%) | rate (%) | (mΩ) |
| Example 1-1 | 0.80 | \ | \ | \ | 13 | 45 |
| Example 2-1 | 0.10 | 10.00 | 3.00 | 0.80 | 6 | 90 |
| Example 2-2 | 0.50 | \ | \ | \ | 9 | 60 |
| Example 2-3 | 1.00 | \ | \ | \ | 16 | 40 |
| Example 2-4 | 2.00 | \ | \ | \ | 7 | 85 |
| Example 2-5 | 0.05 | 10.00 | 3.00 | 0.80 | 5 | 100 |
| Example 2-6 | 2.30 | \ | \ | \ | 5 | 90 |
| Example 2-7 | 0.30 | 10.00 | 3.00 | 0.20 | 8 | 75 |
| Example 2-8 | 0.30 | 10.00 | 3.00 | 0.80 | 8 | 50 |
| Example 2-9 | 0.30 | 10.00 | 3.00 | 0.10 | 8 | 90 |
| Example 2-10 | 0.10 | 10.00 | 3.00 | 0.90 | 8 | 80 |
| Example 2-11 | 0.30 | 5.00 | 3.00 | 0.50 | 8 | 60 |
| Example 2-12 | 0.30 | 10.00 | 3.00 | 0.50 | 8 | 65 |
| Example 2-13 | 0.30 | 15.00 | 3.00 | 0.50 | 8 | 70 |
| Example 2-14 | 0.30 | 3.00 | 3.00 | 0.50 | 8 | 75 |
| Example 2-15 | 0.30 | 17.00 | 3.00 | 0.50 | 8 | 80 |
| Example 2-16 | 0.30 | 10.00 | 1.00 | 0.50 | 8 | 75 |
| Example 2-17 | 0.30 | 10.00 | 5.00 | 0.50 | 8 | 55 |
| Example 2-18 | 0.30 | 10.00 | 0.50 | 0.50 | 8 | 80 |
| Example 2-19 | 0.30 | 10.00 | 6.00 | 0.50 | 8 | 78 |

Note:
“\” in Table 2 indicates no corresponding parameter.

The mass percentage W₁ of the first carbon material generally also affects the internal resistance of the secondary battery. From Examples 1-1 and 2-1 to 2-6, it can be seen that using secondary batteries with the mass percentage W₁ of the first carbon material within the range of this application have lower 360s direct current internal resistance at 20% SOC, indicating that the secondary batteries have lower internal resistance.

When carbon nanotubes are further introduced into the positive electrode active material layer, the mass percentage W₂ of the carbon nanotubes generally also affects the internal resistance of the secondary battery. From Examples 1-1, 2-7 to 2-10, and 2-12, it can be seen that using secondary batteries with the mass percentage W₂ of the carbon nanotubes within the range of this application have lower 360s direct current internal resistance at 20% SOC, indicating that the secondary batteries have lower internal resistance.

The diameter D₂ of the carbon nanotubes generally also affects the internal resistance of the secondary battery. From Examples 2-11 to 2-15, it can be seen that using secondary batteries with the diameter D₂ of the carbon nanotubes within the range of this application have lower 360s direct current internal resistance at 20% SOC, indicating that the secondary batteries have lower internal resistance.

The length L₂ of the carbon nanotubes generally also affects the internal resistance of the secondary battery. From Examples 2-12 and 2-16 to 2-19, it can be seen that using secondary batteries with the length L₂ of the carbon nanotubes within the range of this application have lower 360s direct current internal resistance at 20% SOC, indicating that the secondary batteries have lower internal resistance.

TABLE 3

| | | Mass percentage | | |
|---|---|---|---|---|
| | | W₃ of positive | Electrolyte | Internal |
| | Type of positive | electrode binder | retention | resistance |
| | electrode binder | (%) | rate (%) | (mΩ) |
| Example 2-12 | Polyvinylidene fluoride | 1.20 | 8% | 65 |
| | (Mw = 80 W) | | | |
| Example 3-1 | Polyacrylonitrile | 1.20 | 6% | 75 |
| | (Mw = 100 W) | | | |
| Example 3-2 | Styrene-butadiene | 2.00 | 9% | 70 |
| | rubber (Mw = 120 W) | | | |
| Example 3-3 | Polyvinylidene fluoride | 0.80 | 7% | 70 |
| | (Mw = 80 W) | | | |
| Example 3-4 | Polyvinylidene fluoride | 3.00 | 10% | 90 |
| | (Mw = 80 W) | | | |
| Example 3-5 | Polyvinylidene fluoride | 0.50 | 6% | 95 |
| | (Mw = 80 W) | | | |
| Example 3-6 | Polyvinylidene fluoride | 3.50 | 11% | 100 |
| | (Mw = 80 W) | | | |

The type and mass percentage W₃ of the positive electrode binder generally also affect the internal resistance of the secondary battery. From Examples 2-12 and 3-1 to 3-6, it can be seen that using secondary batteries with the type and mass percentage W₃ of the positive electrode binder within the range of this application have lower 360s direct current internal resistance at 20% SOC, indicating that the secondary batteries have lower internal resistance.

It should be noted that in this document, relational terms such as first and second are only used to distinguish one entity or operation from another entity or operation, and d₀ not necessarily require or imply any such actual relationship or order between these entities or operations. Moreover, the terms “include”, “comprise”, or any other variants thereof are intended to cover non-exclusive inclusion, so that a process, method, article, or device that includes a series of elements not only includes those elements, but also includes other elements not explicitly listed, or also includes elements inherent to such process, method, article, or device.

The various embodiments in this specification are described in a related manner, and the same and similar parts between the various embodiments can be referred to each other. The focus of each embodiment is on the differences from other embodiments.

The above are only preferred embodiments of this application and are not intended to limit this application. Any modifications, equivalent replacements, improvements, etc. made within the spirit and principles of this application should be included in the protection scope of this application.

1. A positive electrode plate, comprising a positive electrode current collector and a positive electrode active material layer disposed on at least one surface of the positive electrode current collector, wherein the positive electrode active material layer comprises a first carbon material;
the first carbon material comprises carbon fibers, and individual carbon black particles and/or chain-like structures formed by the carbon black particles disposed on the surface of the carbon fibers;
a tap density of the first carbon material is 0.005 g/cm³ to 0.30 g/cm³; and
an oil absorption value of the first carbon material is 100 ml/100 g to 1000 ml/100 g.

2. The positive electrode plate according to claim 1, wherein an average particle size of the carbon black particles is d₀ μm, and 0.005≤d₀≤0.1.

3. The positive electrode plate according to claim 1, wherein an average diameter of the carbon fibers is Φ μm, and 0.01≤Φ≤1.00.

4. The positive electrode plate according to claim 3, wherein 1.5≤Φ/d₀≤8.

5. The positive electrode plate according to claim 3, wherein the positive electrode plate satisfies at least one of the following features:
(a) 0.01≤d₀≤0.05; or
(b) 0.05≤Φ≤0.1.

6. The positive electrode plate according to claim 1, wherein an average length of the first carbon material is L₁ μm, and 1≤L₁≤50.

7. The positive electrode plate according to claim 1, wherein an average diameter of the first carbon material is D₁ μm, and 0.2≤D₁≤5.

8. The positive electrode plate according to claim 1, wherein the first carbon material satisfies at least one of the following features:
(1) the tap density of the first carbon material is 0.01 g/cm³ to 0.06 g/cm³;
(2) the oil absorption value of the first carbon material is 400 ml/100 g to 700 ml/100 g;
(3) a length of the first carbon material is L₁ μm, and 2≤L₁≤15; or
(4) a diameter of the first carbon material is D₁ μm, and 0.5≤D₁≤2.

9. The positive electrode plate according to claim 1, wherein based on a mass of the positive electrode active material layer, a mass percentage of the first carbon material is W₁%, and 0.1≤W₁≤2.0.

10. The positive electrode plate according to claim 1, wherein based on a mass of the positive electrode active material layer, a mass percentage of the first carbon material is W₁%, and 0.3≤W₁≤1.0.

11. The positive electrode plate according to claim 1, wherein the positive electrode active material layer comprises a second carbon material, the second carbon material comprises carbon nanotubes, an average diameter of the carbon nanotubes is D₂ nm, wherein 5≤D₂≤15, and an average length of the carbon nanotubes is L₂ μm, wherein 1≤L₂≤5; and
based on a mass of the positive electrode active material layer, a mass percentage of the carbon nanotubes is W₂%, wherein 0.2≤W₂≤0.8.

12. The positive electrode plate according to claim 1, wherein the positive electrode active material layer comprises a positive electrode binder; and the positive electrode binder comprises at least one of polyvinylidene fluoride, vinylidene fluoride-hexafluoropropylene copolymer, polyacrylonitrile, polyacrylate, polyacrylic acid, polyacrylate salt, polyvinylpyrrolidone, polyamide, polyvinyl ether, polymethyl methacrylate, polytetrafluoroethylene, polyhexafluoropropylene, styrene-butadiene rubber, polypropylene, polyethylene, polytetrafluoroethylene, polyetherimide, hydrogenated nitrile rubber, or carboxymethyl cellulose salt; and
based on a mass of the positive electrode active material layer, a mass percentage of the positive electrode binder is W₃%, and 0.8≤W₃≤3.0.

13. The positive electrode plate according to claim 1, wherein a saturated electrolyte retention rate of the positive electrode plate is 5% to 20%.

14. A secondary battery, wherein the secondary battery comprises a positive electrode plate, and the positive electrode comprises a positive electrode current collector and a positive electrode active material layer disposed on at least one surface of the positive electrode current collector, wherein the positive electrode active material layer comprises a first carbon material;
the first carbon material comprises carbon fibers, and individual carbon black particles and/or chain-like structures formed by the carbon black particles disposed on the surface of the carbon fibers;
a tap density of the first carbon material is 0.005 g/cm³ to 0.30 g/cm³; and
an oil absorption value of the first carbon material is 100 ml/100 g to 1000 ml/100 g.

15. The secondary battery according to claim 14, wherein an average particle size of the carbon black particles is d₀ μm, and 0.005≤d₀≤0.1.

16. The secondary battery according to claim 14, wherein an average diameter of the carbon fibers is Φ μm, and 0.01<Φ<1.00.

17. The secondary battery according to claim 16, wherein 1.5≤Φ/d₀≤8.

18. The secondary battery according to claim 16, wherein the positive electrode plate satisfies at least one of the following features:
(a) 0.01≤d₀≤0.05; or
(b) 0.05≤Φ≤0.1.

19. The secondary battery according to claim 16, wherein an average length of the first carbon material is L₁ μm, and 1≤L₁≤50.

20. An electronic device, wherein the electronic device comprises the secondary battery according to claim 14.
